(19) United States
(12) Patent Application Publication
(10) Pub. No.: US 2012/0240353 A1
(43) Pub. Date: Sep. 27, 2012

(54) APPARATUS FOR PASSENGER HANDLE FOR A MOTOR VEHICLE

(76) Inventor: Jonathan Scott Byler, San Jose, CA (US)

(21) Appl. No.: 13/072,754

(22) Filed: Mar. 27, 2011

(51) Int. Cl. B60N 3/02

(52) U.S. Cl. 16/110.1

(57) ABSTRACT

Disclosed herein is an apparatus for assisting a passenger on a motor vehicle to hold unto the driver and stay connected to such a vehicle during vehicle operation. The apparatus of the instant includes a length of material, which is folded and permanently secured in the folded position. At least two loops are formed from the material. The first loop is secured, non-permanently, attached to the driver; usually through the driver's belt. The second loop serves as a handle. The passenger grips onto the handle, providing an easier and more secure grip of the driver. The material for making the passenger handle is typically the same type of material for making seat belts. The material is preferable flexible and easy to grip and strong enough to provide secure connection with the driver while operating the motor vehicle.

### FIELD OF THE INVENTION

This invention relates generally to the field of motor vehicles, which facilitates a passenger's ability to hold unto the driver during operation. Thus, the invention relates generally to motor vehicles, which require at least some degree of balance during operation. More particularly, this invention relates to motor vehicles such as a motorcycle, a snowmobile, personal watercraft and/or any such vehicle where the passenger needs his/her ability to hold unto the driver as a means of support.

### BACKGROUND OF THE INVENTION

In an ordinary motor vehicle, a passenger sits passively in a seat, such as a two or four door car or truck. A passenger sits in the chair and straps himself or herself into the seat and remains relatively stationary while the vehicle is in motion. Handgrips are not required, unless there is some sort of emergency condition during vehicle operation.

Other motor vehicles, such as motorcycles, snowmobiles, and personal watercraft require a passenger to dynamically hold onto either or both of the vehicle or the driver to maintain contact with the vehicle. Ordinarily there is no specialized support structure for the passenger to facilitate this function. The passenger either grabs onto some feature of the motor vehicle or the driver. However, passenger accidents occur, even where the vehicle does not crash. What is needed is a device and method for facilitating the passenger's ability to remain on such a motor vehicle during operation.

As experience teaches us, the driver, by himself is not meant for such support. The driver must focus his primary attention on the driving and not the passenger. Additionally, the driver must not allow the passenger to intrude upon his or her driving to the point of causing an accident.

As noted above, typically, these types of vehicles require balance. The driver does not merely turn the steering wheel, like with automobile, but leans into the turns. It is most helpful, when the passenger and driver do so in synch. Otherwise; the driver and passenger become dynamically at odds and the risks for accidents greatly increase. What is needed is a structure, which facilitates passenger support, but also encourages passenger and driver synchronization.

While some balance oriented motor vehicles, such as motorcycles, provide some modest support for the passenger, it is typically inadequate. In pleasant weather, when motorcycle use is greatly increased, one need only pick up the paper in any city and find passenger injury-related accidents, where the motorcycle did not crash, but the passenger was hurt or killed.

It is believed that these types of injuries and even deaths are mostly preventable by providing the passenger with proper support. However, it is not believed that motorcycle manufacturers or the makers of similar vehicles can greatly improve passenger support. It must be remembered that the passenger and the driver must be in-synch. Thus, providing additional structural supports on the motorcycle or like could and perhaps even make more likely increased frequency of vehicle accidents. When the passenger gets his/her support from the vehicle itself instead of the driver of such vehicles, there is a greater danger that the passenger and driver will not be in-synch and as noted above, this may well result in a greater frequency of motorcycle and similar equipped vehicle crashes.

Instead, what is needed is a device, apparatus or method for facilitating passenger support while also encouraging the passenger to stay in-synch with to a greater degree with the driver. At the very least, such a device apparatus and method should encourage support, while not interfering with the driver's ability to operate such a motor vehicle.

### SUMMARY OF THE INVENTION

In order to facilitate passenger support on a balance-oriented motor vehicle, the invention provides a length of material, folded into two members. A first member attaches to the driver of the motor vehicle and a second member is provided for gripping by the passenger during operation.

It is an object of this invention to provide an apparatus, which facilitates the passenger holding onto the driver during motor vehicle operation.

It is an additional object of this invention to provide such an apparatus, which facilitates passenger support, while not interfering with the driver's ability to operate the motor vehicle.

It is an additional object of this invention to provide such an apparatus, which facilitates passenger support, while not encouraging passenger and driver synchronization during the operation the motor vehicle.

It is an additional object of this invention to provide such an apparatus, which is simple to use and inexpensive.

In accordance with the above objects and those that will be mentioned and will become apparent below, the apparatus in accordance with this invention comprises:

a passenger handle for assisting a passenger connection to the driver during motor vehicle operation, the passenger handle comprising:

a length of safety belt-type fabric;

the length of safety belt-type fabric folded to define two members, a first member and a second member;

the first member for connection to the driver of the motor vehicle; and the second member defining a gripping member for the passenger for facilitating the passenger being able to hold onto the driver during vehicle operation.

In a exemplary embodiment of the apparatus in accordance with the invention, the handle is created by folding over the length of material and creating a first and a second loop. The second loop being made from material, which is strong and yet comfortable to grip. The loops being permanently created by sewing.

In another preferred embodiment, the length of material is folded over to define a FIG. 8 and the FIG. 8 folds define a cross-over zone where the material overlaps and the loops are permanently fixed at the cross-over zone by sewing the contacting portions of the material together.

In another preferred embodiment, each of the loops is approximately the same size. In another preferred embodiment, the loops are of different diameters. In an exemplary embodiment, the first loop is larger than the second. In another exemplary embodiment, the second loop is larger than the first.

It is an advantage of this invention to a provide a simple, yet effective apparatus for facilitating passenger support on a balance-type vehicle, which does not interfere with the driver's ability to operate the motor vehicle.

It is another advantage of this invention to a provide a simple, yet effective apparatus described herein which not only facilitates passenger support, but encourages synchronization between driver and passenger on a balance-type vehicle.

### BRIEF DESCRIPTION OF THE DRAWING

For a further understanding of the objects and advantages of the present invention, reference should be had to the following detailed description, taken in conjunction with the accompanying drawing, in which like parts are given like reference numerals and wherein:

FIG. 1 is a perspective view of an exemplary embodiment of the invention, a passenger handle.

FIG. 2 is a perspective view of an exemplary embodiment of the invention, a passenger handle, in use.

FIG. 3 is an perspective view of an exemplary embodiment of the invention, a passenger handle, in use, during operation of a motor vehicle.

### DETAILED DESCRIPTION OF THE INVENTION

In order to appreciate the invention herein, one must appreciate the need in the art as set forth in the Background. Most importantly, the structure herein for resolving the long felt need to facilitate improved passenger support on a balance-type motor vehicle without interfering with the driver's ability to operate the motor vehicle. And, when truly successful, the apparatus in accordance with the invention actually encourages passenger—driver synchronization, thereby providing a safer and more enjoyable experience for both passenger and driver.

The invention will now be described with respect to FIG. 1, which illustrates a preferred embodiment of the invention shown generally by the numeral 10, a passenger handle.

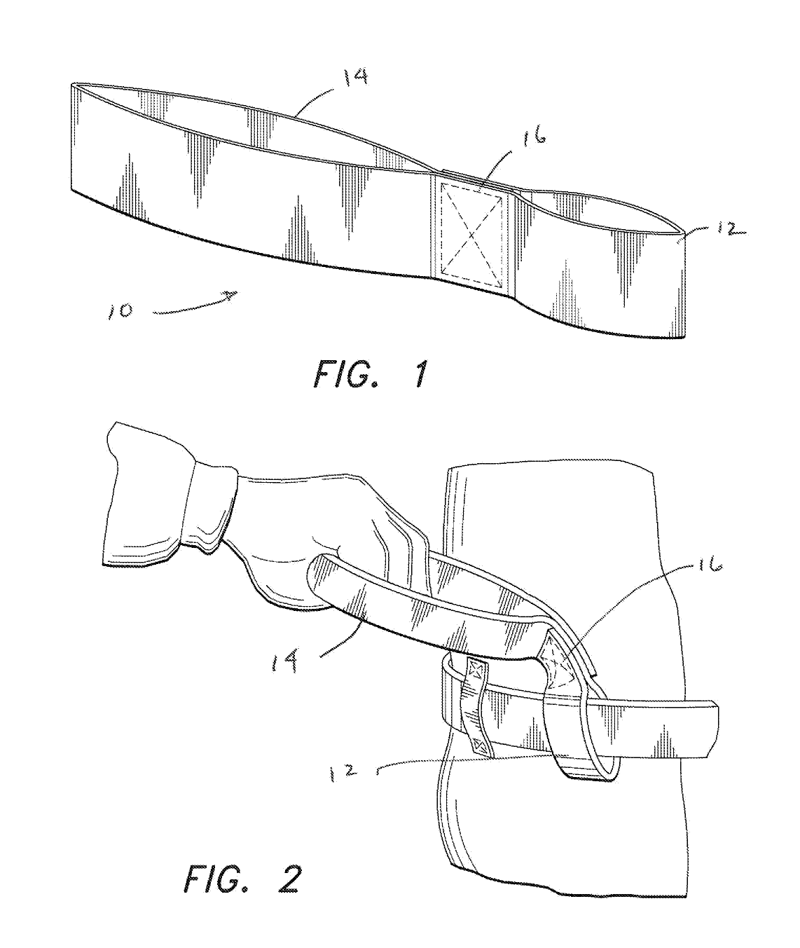

The passenger handle 10 is created from a length of material and folded into a FIG. 8 as clearly shown in FIGS. 1 & 2. The FIG. 8 defines a first loop 12 and a second loop 14. In the exemplary embodiment shown in FIG. 1, the first loop 12 is smaller than the second loop 14. As shown in FIG. 2, the first loop 12 fits to the driver of the motor vehicle through the driver's belt.

It goes without further explanation that the driver may wear any type of pants, shorts, jeans, slacks and the like. In fact, no pants are necessary for carrying out the invention. All that is required is that the driver wear a belt wrapped around his or her torso. However, it is recommended that the driver use pants and more particularly use pants with belt loops. This assures the passenger the best grip possible using the passenger handle 10 in accordance with the invention.

Once the length of material is folded over a crossover zone 16 is defined between the first loop 12 and the second loop 14. Once the loops 12, and 14 are formed to the desired sizes, they are permanently affixed by, in an exemplary embodiment, sewing the material throughout the crossover zone 16 to the overlapping layers. Of course, it will be appreciated that other means of permanent attachment at the crossover zone are likewise possible within the spirit and scope of the invention. For example, in an exemplary embodiment glue is used. In yet another embodiment, rivet-type structures are used.

In the first described and illustrated embodiment, the loops 12 and 14 are of different sizes. It will, of course, be appreciated, that within the spirit and scope of the invention, the first loop may be smaller or the same size as the second loop. The important aspect of the invention concerning sizes is that the passenger handle 10 be configured so that the passenger is secure as possible without affecting the driver's ability to operate the motor vehicle.

In an exemplary embodiment, the material of the passenger handle 10 is regular safety belt material, such as that used in an automobile. In another exemplary embodiment, the material used is a heavy gauge safety belt material, such as that used in auto racing. In yet another exemplary embodiment, the material is a dual durometer.

In such an exemplary embodiment, one element of the material has the strength of a safety belt material, the other portion is made from a polyethylene type material for providing greater comfort and more secure gripping by the passenger. So, for example, the first loop 12 used for attachment to the driver is primarily composed of safety belt material, while the second loop 14 include a greater amount of PE for ease and comfort in gripping the handle.

Many combinations of plasticized safety belt material are possible within the spirit and scope of the invention. The key function is to maintain the strength of the handle 10, while providing additional comfort and greater gripping ability for the passenger.

In an exemplary embodiment, the length of material is 8 inches long and 1.5 inches wide. Additionally, the first loop 12 is 2 inches long and the second loop 14 is 5.5 inches long. In this exemplary embodiment, the crossover zone is 0.5 inches.

Thus, the exemplary embodiment described above is capable of being tightly folded and a pair of such handles 10 easily fits into the pocket of a driver or a passenger, when not in use. As noted above various dimensions are possible within the spirit and scope of the invention and no specific dimension, but rather its function is the important feature of the invention herein. Using the dimensions noted above, passenger handle 10 not only performs all of its function, but also stores conveniently on the person of the driver or passenger, when not in use.

In Use:

As shown in FIGS. 2 & 3, the passenger handle 10 fits through the belt of the driver. Specifically, the belt is threaded through the first loop 12. The driver's belt is threaded through the loops of his or her pants. The passenger then holds onto the second loop 14.

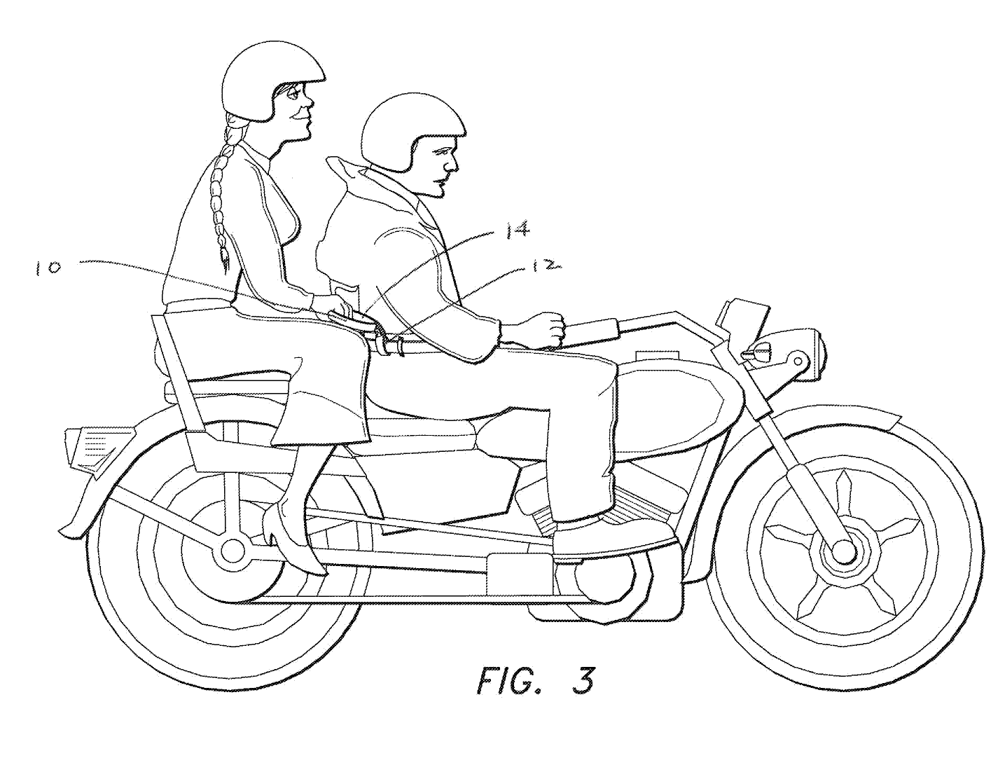

In the exemplary embodiment shown in FIG. 3, the passenger is shown holding the passenger handle 10 in the upright position. It will be appreciated within the spirit and scope of the invention that the passenger, on a different motor vehicle, would find it more convenient and perhaps even safer to use the handle 10 in the downward position.

Additionally, the passenger handle 10 serves as an inexpensive highly reliable means of communication between passenger and driver. For example, after arriving at an agreement between passenger and driver, the passenger can signal the driver asking for a break; slow down, speed up, ready and the like.

While the foregoing detailed description has described several embodiments of the passenger handle in accordance with this invention, it is to be understood that the above description is illustrative only and not limiting of the disclosed invention. Particularly, there are different materials and dimensions of the various elements that are all within the spirit and scope of the invention. It will be appreciated that the embodiments discussed above and the virtually infinite embodiments that are not mentioned could easily be within the scope and spirit of this invention. Thus, the invention is to be limited only by the claims as set forth below.

What is claimed is:

1. A passenger handle for assisting a passenger connection to the driver during motor vehicle operation, the passenger handle comprising:
a length of safety belt-type fabric;
the length of safety belt-type fabric folded to define two members, a first member and a second member;
the first member for connection to the driver of the motor vehicle; and
the second member defining a gripping member for the passenger for facilitating the passenger being able to hold onto the driver during vehicle operation.

2. The passenger handle as set forth in claim 1, wherein the seat belt fabric is made from a nylon based material.

3. The passenger handle as set forth in claim 1, wherein the length of fabric is folded over itself to define a FIG. 8—having a first and a second loop.

4. The passenger handle as set forth in claim 3, wherein the FIG. 8 defines a cross-over zone between the first and the second loops.

5. The passenger handle as set forth in claim 4, wherein at the FIG. 8 crossover, the loops are permanently fixed defining an attachment zone.

6. The passenger handle as set forth in claim 5, wherein at the FIG. 8 crossover, the loops are permanently fixed at the attachment point by sewing the contacting portions of the fabric together.

7. The passenger handle as set forth in claim 6, wherein the two loops are consistent with the first and second members.
